(19) United States
(12) Patent Application Publication
(10) Pub. No.: US 2007/0289480 A1
(43) Pub. Date: Dec. 20, 2007

(54) ANTISTATIC COATING COMPOSITION AND ANTISTATIC FILM COATED WITH THE COMPOSITION

(76) Inventors: Kun-Hsuan Yang, Taoyuan County (TW); Kuan-Kuo Lai, Tao-Yuan Hsien (TW); Chin-Sung Chen, Taoyuan County (TW); Po-Tau Liu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/690,119

(22) Filed: Mar. 22, 2007

(30) Foreign Application Priority Data
Jun. 14, 2006 (TW) 095121252

(51) Int. Cl. C09K 3/18; C08F 2/48

(52) U.S. Cl. 106/2; 427/508

(57) ABSTRACT

This invention provides an antistatic coating composition and antistatic hard coating film coated with the composition. The antistatic coating composition, which comprises curable hard coating solution mixed with antistatic coating recipe, contains no conductive fine powder or fine particle, thus can be preserved longer. The antistatic hard coating film has superior antistatic ability, higher transmittance=and has no visible color shift.

### BACKGROUND OF THE INVENTION

1. Field of the Invention

The present invention relates to an antistatic coating composition. More particularly, the present invention relates to an ionic antistatic hard coat liquid composition curable by UV light and a method of fabricating an antistatic film with the composition.

2. Description of the Prior Art

In recent years with the improvement and development of manufacturing techniques of semiconductor and optoelectronic elements, displays such as liquid crystal displays, i.e. LCDs, or plasma display panel, i.e. PDPs, have become more and more popular. In order to prevent the displays from being scratched by external forces or dust accumulation, antistatic films are usually applied on the displays.

The conventional method for fabricating the antistatic films is that a transparent conductive film, such as indium tin oxide (ITO), is applied on a transparent substrate. Then a transparent and scratch-resistant hard coat film is first applied on the conductive film then cured, or vice versa, of course. The conventional method for fabricating the antistatic films may add conductive fine particles into the hard coat films to increase the anti-static ability. One of the relevant prior arts is U.S. Pat. 6,146,753 “Antistatic Hard Coat Film.”

Other relevant prior arts are, for example, Japan publication number 55-78070 “ULTRAVIOLET-CURING, CONDUCTIVE PAINT”; Japan publication number 04-172634 “MATERIAL FOR OPTICAL DISC AND HARDENED COMPOUND THEREOF”; Japan publication number 02-194071 “CONDUCTIVE COATING COMPOSITION” Japan publication number 60-060166 “PHOTOCURABLE ELECTRICALLY CONDUCTIVE PAINT COMPOSITION”; Japan publication number 06-264009 “CONDUCTIVE COATING COMPOSITION AND PRODUCTION OF CONDUCTIVE COATING FILM”; Japan publication number 2001-131485 “COATING FOR FORMING TRANSPARENT ELECTROCONDUCTIVE FILM AND TRANSPARENT ELECTROCONDUCTIVE FILM.”

However, the above-mentioned prior arts still have problems to be improved and solved. For example, the composition disclosed in 55-78070 does not have sufficient transparency due to the larger diameter of chain metal powder. The composition disclosed in 60-060166 has large quantity of uncured dispersants and accordingly the cured film does not have sufficient hardness. The material disclosed in 04-172634 has low transparency due to high concentration of inorganic particles. The coating composition in 06-264009 is not suitable for long-term storage.

Hence, persons who have ordinary skills in the art may come to the conclusion that the anti-static ability of the antistatic film can be improved by increasing the content of the conductive particles, however, it would decrease the transmission or transparency of the antistatic film due to absorption or reflection of visible light by conductive particles. Generally speaking, the maximum transmission available in the art can hardly be improved anymore. If the content of conductive particles is lower, the anti-static ability is prone to be insufficient.

The stability of long-term storage for the conventional film paint containing conductive particles is poor after preparation because of the sedimentation of the conductive particles. It is not convenient for using because the paint requires to be re-dispersed after long-term storage. Once the content of the conductive particles is over, the wear-resistant ability of the antistatic film would be decreased.

In addition, the conductive particles are somewhat colored, and increasing the content of conductive particles may result in visible color shift. Moreover, the know-how of dispersing the conductive particles is very important for the quality of antistatic film.

### SUMMARY OF THE INVENTION

This invention in one aspect provides a composition of antistatic coating solution which can be easily prepared and readily stored, and a method for fabricating an antistatic film using the composition. The antistatic film has superior antistatic ability, higher transmittance and has no visible color shift.

According one preferred embodiment of the present invention, the present invention provides an ionic antistatic coating composition, comprising:

a saturated polymer represented by the following formula:

—[CₙH₂ₙ—X—CₘH₂ₘ—Y]—

wherein, n is a number from 2 to 5, m is a number from 2 to 5, X is oxygen, nitrogen, or sulfur, Y is oxygen, nitrogen, or sulfur, and X and Y provide lone pair electrons;

at least one inorganic metal salt comprising a metal cation and an anion, and a positive charge of the cation is stabilized by the lone pair electrons provided by X and Y;

a UV-curing resin curable by radiation of UV light; and

an organic solvent exerting a better solvation effect on the anion and cation.

According to another preferred embodiment of the present invention, the present invention provides a method for fabricating an antistatic hard coating film, comprising:

providing a transparent substrate;

coating an ionic antistatic coating composition on the transparent substrate, wherein the ionic antistatic coating composition comprises an inorganic metal salt comprising a metal cation and an anion, a saturated polymer providing lone pair electrons to stabilize the metal cation, a UV-curing resin, and an organic solvent exerting a solvation effect on the anion and cation;

performing a drying process to vaporize the organic solvent; and

performing a UV radiation process to allow the UV-curing resin to proceed a cross-linking polymerization reaction, and, thereby, forming an antistatic hard coating on the transparent substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the stable structure formed by the saturated polymer and the inorganic metal ions of the preferred embodiment of the present invention.

FIG. 2 illustrates the charges from an exterior system are neutralized by the charge separation of the saturated polymer and the inorganic metal ions of the preferred embodiment of the present invention.

FIG. 3 illustrates the test results of the hardness, total transmittance, haze and surface resistance of the antistatic film.

FIG. 4 illustrates the test results of the transmittance and the as value and the bs value of the antistatic film.

### DETAILED DESCRIPTION

As described earlier, the preparation of the antistatic film in the prior art is usually accomplished by adding conductive particles which result in problems such as low transmission or transparency, poor stability and technical issues such as poor dispersion and color shift. To solve these problems, unlike those in the prior art, the present invention provides a solution with no inorganic conductive particles added. By doing so, problems like low transmission or transparency, poor stability and technical issues such as poor dispersion and color shift would all no longer exist.

The present invention provides an ionic antistatic coating composition, comprising a saturated polymer; inorganic metal salt; a UV-curing resin curable by radiation of UV light; and a volatile organic solvent. The ionic antistatic coating composition of the present invention does not contain solid conductive powders or particles.

The saturated polymer is of the following formula:

—[CₙH₂ₙ—X—CₘH₂ₘ—Y]—

wherein, n=2-5, m=2-5, X is oxygen, nitrogen, or sulfur, Y is oxygen, nitrogen, or sulfur atom, and X and Y provide lone pair electrons. According to one preferred embodiment of the present invention, the saturated polymer may be a cross-linked copolymer of polypropylene oxide (PPO) and polyethylene oxide (PEO). In addition, the saturated polymer may be a polymer of identical monomer, such as PPO or PEO.

The inorganic metal salt includes a metal cation and an anion. According to one preferred embodiment of the present invention, the inorganic metal salt has a lower lattice energy such as Li, Na, K, Rb and Li is preferred. The anion is preferably the perchlorate ion but not limited to this. In other embodiments, the inorganic metal salt may include LiAsF₆, LiPF₆, LiBF₄ or other similar ion-conducting additives, too.

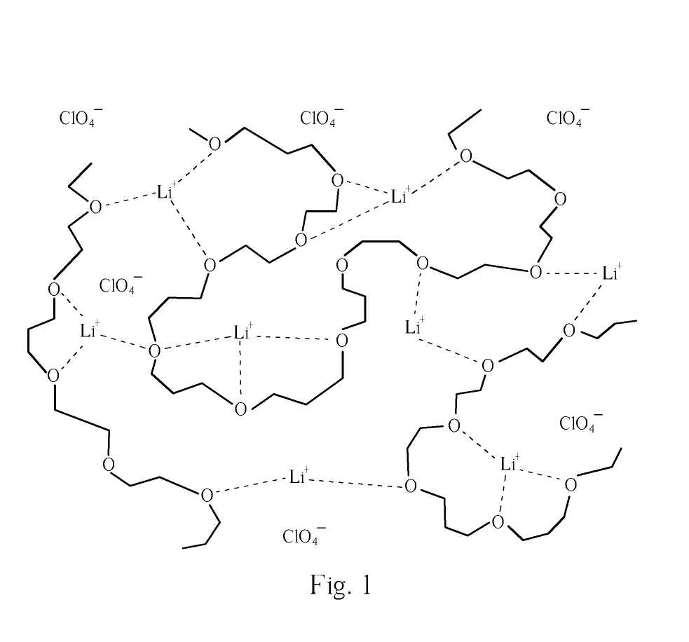

The positive charge of the cation, Li⁺ for example, is stabilized by the lone pair electrons provided by oxygen atoms of the cross-linked copolymer PPO and PEO. The entangled polymer chains delocalize the positive charges of the Li ions and segregate the negative charges of perchlorate ions effectively to render a charge separation of the system, as shown in FIG. 1.

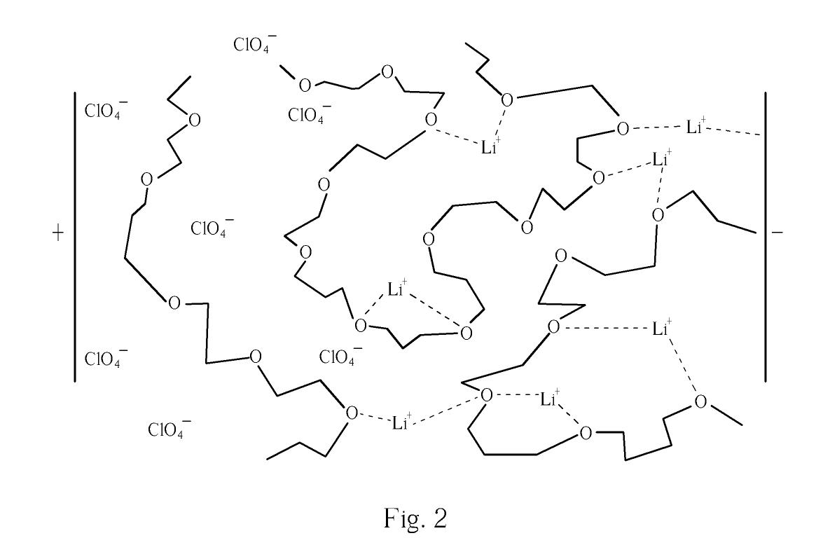

As shown in FIG. 2, the charge separation of the system may effectively neutralize the charges from an exterior system and the system is conductive to reduce the absorption of dust.

The UV-curing resin curable by radiation of UV light includes acryl resins and is not limited to this. The UV-curing resins may be used along with the photo initiators such as acetophenone, benzophenone and oligomers. Additional features of these traditional additives will not be described in detail here.

The saturated polymers and the inorganic metal salts are the basic ingredients of the conductive coating liquid composition. The UV-curing resin, the photo initiators, the oligomers and the volatile organic solvents are the basic ingredients of the hard coat liquid composition.

The polar solvents include isopropanol (IPA), ethyl acetate, 1-methoxy-2-propanol and the like. The organic solvents may be used alone or in combination.

One of the main features of the present invention resides in the “saturated” polymer in the ionic antistatic coating composition, i.e., the composition should not include the double bond or conjugated double bond structure such as phenyl structure, aniline or thiofuran, which would absorb the UV-light. If the polymer includes the UV-absorbing double bond or conjugated double bond structure, they may be involved in the following photochemical reaction of the UV-curing resin and jeopardize the cross-linking polymerization of the UV-curing resin. Besides, the absorbing coefficients of different conjugated double bond structures would be different according to the light having different wavelengths and result in color shift.

In addition, to simplify the process and to increase the yield, another feature of the present invention lies in the combination of the separated hard coat film and the antistatic conductive film in the prior art. Therefore, the choice of the antistatic conductive materials relies on the materials that are structurally supported by being entangled with the polymers of the UV-curing resin in the hard coating composition and dispersed in the composition uniformly.

Because the polymeric materials of the present invention dissolve in the hard coating composition too, the conductive coating composition and hard coating composition can be mixed up to form the ionic antistatic coating composition and applied on a transparent substrate. Later the drying process and the UV radiation process are performed to allow the resin to be cured to obtain the antistatic hard coating film with superior antistatic ability, higher transmittance and no visible color shift.

The method of fabricating the antistatic coating composition of the present invention substantially includes the following four steps:

(1) providing a transparent substrate, such as polyester and triacetate cellulose (TAC);

(2) coating an ionic antistatic coating composition on the transparent substrate, wherein the ionic antistatic coating composition includes an inorganic metal salt including a metal cation and an anion, a saturated polymer providing lone pair electrons to stabilize the metal cation, a UV-curing resin, and an organic solvent exerting an effective solvation effect;

(3) performing a drying process to vaporize the organic solvent, wherein the drying process may be performed under a condition between 60-70° C. for about 1 minute; and

(4) performing a UV radiation process to allow the UV-curing resin to proceed a cross-linking polymerization reaction, and, thereby, forming an antistatic hard coating on the transparent substrate, wherein the intensity of the UV light is 0.242 W/cm² and the dosage is between 300-350 mJ/cm².

The following is an example provided to illustrate the preparation of the antistatic coating composition of the present invention in detail, as well as the test results of the antistatic film. The present invention provides a method for fabricating an antistatic coating composition of easy preparation, high storage stability and uniform dispersion.

Preparation of the Ionic Antistatic Coating Composition

[Preparation of the Hard Coating Composition]

Commercially available hard coating material RC-610R from Nissan Chemical Co., which is a UV-curing resin of acrylic type, is dissolved in a solvent containing isopropanol, ethyl acetate and 1-methoxy-2-propanol in a ratio (v/v) of 1:1:1 to obtain a hard coating solution in the concentration of 40% (w/w). The concentration depends on the thickness of the desired film. The suitable concentration may be between 20%-70%, preferably 40%.

[Preparation of the Conductive Coating Solution]

The product PEL-20A from the PEL product series of Japan Carlit Co. is a cross-linked co-polymer of PPO and PEO and contains 20% inorganic salt, LiClO₄. Also, PEL-100 or PEL-20BBL may be suitable.

[Preparation of the Ionic Antistatic Coating Solution]

20 g of the hard coating solution of 40% solid content is added into 2%, 4%, 6%, 8%, 10%, and 12% PEL conductive coating solution respectively and the hard coating solution and the conductive coating solution are mixed uniformly by stirring.

[Preparation of 40% Hard Coating Solution]

40 g of RC-610R gel of solid content 100% is added into the solvent containing each ethyl acetate, isopropanol and 1-methoxy-2-propanol of 20 g and the mixture is mixed uniformly by stirring.

[Preparation of Hard Coating Antistatic Liquid Composition]

2% concentration: 0.408 g of PEL20A is added into the 40% hard coating solution and the mixture is mixed uniformly by stirring.

4% concentration: 0.833 g of PEL20A is added into the 40% hard coating solution and the mixture is mixed uniformly by stirring.

6% concentration: 1.276 g of PEL20A is added into the 40% hard coating solution and the mixture is mixed uniformly by stirring.

8% concentration: 1.739 g of PEL20A is added into the 40% hard coating solution and the mixture is mixed uniformly by stirring.

10% concentration: 2.222 g of PEL20A is added into the 40% hard coating solution and the mixture is mixed uniformly by stirring.

12% concentration: 2.727 g of PEL20A is added into the 40% hard coating solution and the mixture is mixed uniformly by stirring.

Test Results

The ionic antistatic coating composition is applied on a TAC transparent substrate of 80 μm thickness. A drying process is later performed under a condition between 60-70° C. for about 1 minute. Then a UV radiation process is performed to allow the UV-curing resin to proceed a cross-linking polymerization reaction, and, thereby, forming an antistatic hard coating on the transparent substrate. The intensity of the UV light is 0.242 W/cm² and the dosage is between 300-350 mJ/cm². Finally, the total thickness of the film is 85 μm.

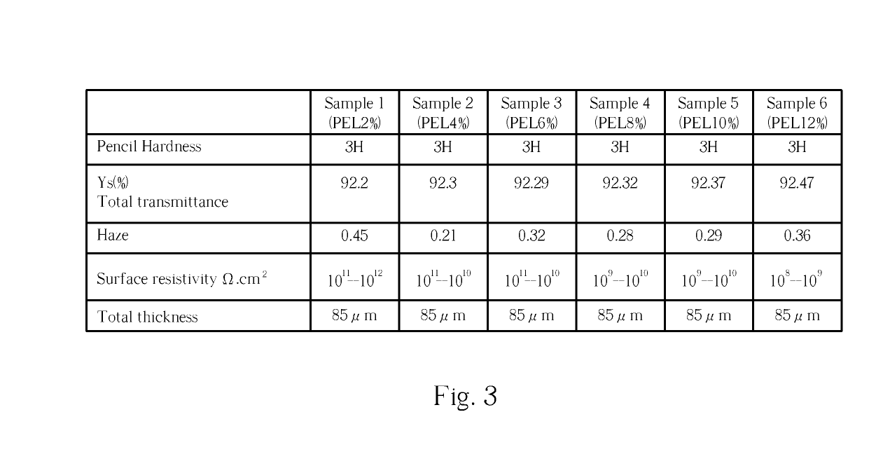

Tests are conducted according to the following standards to test the hardness, total transmittance, haze and surface resistance. The results are shown in FIG. 3.

Pencil Hardness: Tested by Scratch Hardness Tester Model 291 from Erichsen Testing Equipment. The load is 500 g and the hardness of the pencil is 3H.

Total Transmittance and Haze: Tested by Haze meter NDH2000 from Nippon Denshoku.

Surface Resistance: Tested by Resistivity meter 1824 from BJZ. The voltage is 500 V. According to the preferred embodiment of the present invention, the preferred surface resistance is between 10⁸-10¹² Ωcm², most preferred 10⁹ Ωcm². If the surface resistance is larger than 10¹² Ωcm², the wear-resistant ability may be weakened.

LPF100 from Otsuka Tech Electronics is used to test the transmittance of the visible light band (380 nm-780 nm) to analyze the Hue (as and bs values) of the film.

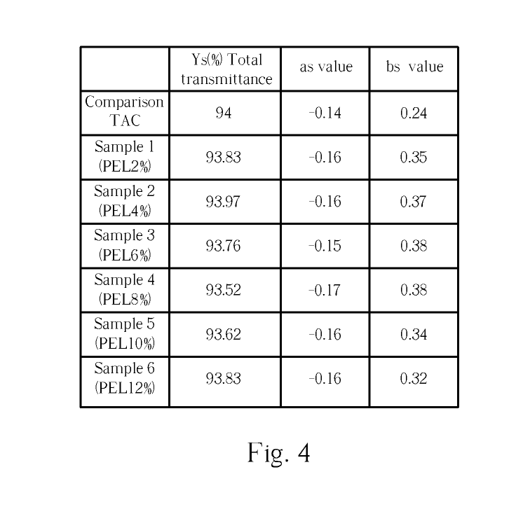

The test results in FIG. 3 and FIG. 4 show that an antistatic hard coating film with high transmittance and no visible color shift can be obtained through the UV light radiation. The transmittance is higher than 92% and the as value and the bs value are almost identical to those of the transparent substrate. In addition, the concentration of the PEL conductive coating solution does not affect the dispersion. The high concentration of PEL conductive coating solution does not affect the as value and the bs value and the transmittance of the antistatic film either.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A composition of an ionic antistatic coating solution, comprising:
a saturated polymer represented by the following formula:
—[CₙH₂ₙ—X—CₘH₂ₘ—Y]—
wherein, n is a number from 2 to 5, m is a number from 2 to 5, X is an oxygen, nitrogen, or sulfur atom, Y is an oxygen, nitrogen, or sulfur atom, X and Y provide lone pair electrons;
at least one inorganic metal salt having a low lattice energy, wherein the inorganic metal salt comprises a metal cation and an anion whose ionic radius is larger than the cation, and a positive charge of the cation is stabilized by the lone pair electrons provided by X and Y;
a UV-curing resin curable by radiation of UV light; and
an organic solvent exerting a solvation effect on the anion and cation.

2. The composition of claim 1, wherein the saturated polymer is copolymerized from polypropylene oxide (PPO) and polyethylene oxide (PEO).

3. The composition of claim 1, wherein the saturated polymer is polypropylene oxide (PPO) or polyethylene oxide (PEO).

4. The composition of claim 1, wherein the metal cation comprises lithium (Li), sodium (Na), potassium (K), or rubidium (Rb).

5. The composition of claim 1, wherein the anion comprises perchlorate ion.

6. The composition of claim 1, wherein the UV-curing resin comprises acryl resin.

7. The composition of claim 1, wherein the organic solvent comprises isopropanol (IPA), ethyl acetate, or 1-methoxy-2-propanol.

8. A method of fabricating an antistatic hard coating film, comprising:
providing a transparent substrate;
coating an ionic antistatic coating composition on the transparent substrate, wherein the ionic antistatic coating composition comprises an inorganic metal salt comprising a metal cation and an anion, a saturated polymer providing lone pair electrons to stabilize the metal cation, a UV-curing resin, and an organic solvent;
performing a drying process to vaporize the organic solvent; and
performing a UV radiation process to allow the UV-curing resin to proceed a crosslinking polymerization reaction, and, thereby, forming an antistatic hard coating on the transparent substrate.

9. The method of claim 8, wherein the transparent substrate comprises polyester or triacetate cellulose (TAC).

10. The method of claim 8, wherein the saturated polymer is represented by the following formula:
—[CₙH₂ₙ—X—CₘH₂ₘ—Y]—
wherein, n is a number from 2 to 5, m is a number from 2 to 5, X is an oxygen, nitrogen, or sulfur atom, Y is an oxygen, nitrogen, or sulfur atom.

11. The method of claim 8, wherein the saturated polymer is copolymerized from polypropylene oxide (PPO) and polyethylene oxide (PEO).

12. The method of claim 8, wherein the saturated polymer is polypropylene oxide (PPO) or polyethylene oxide (PEO).

13. The method of claim 8, wherein the metal cation comprises lithium (Li), sodium (Na), potassium (K), or rubidium (Rb).

14. The method of claim 8, wherein the anion comprises perchlorate ion.

15. The method of claim 8, wherein the UV-curing resin comprises acryl resin.

16. The method of claim 8, wherein the organic solvent comprises isopropanol (IPA), ethyl acetate, or 1-methoxy-2-propanol.
